(19) United States
(12) Patent Application Publication
(10) Pub. No.: US 2008/0121462 A1
(43) Pub. Date: May 29, 2008

(54) Tilt Forward Ladder

(75) Inventors: Eric Pucek, Salina, PA (US); Timothy Resciniti, Pittsburgh, PA (US)

Correspondence Address: THE WEBB LAW FIRM, P.C., 700 KOPPERS BUILDING, 436 SEVENTH AVENUE, PITTSBURGH, PA, 15219, US

(73) Assignee: TRI-ARC MANUFACTURING CO., Pittsburgh, PA (US)

(21) Appl. No.: 11/937,874

(22) Filed: Nov. 9, 2007

Related U.S. Application Data
(60) Provisional application No. 60/859,821, filed on Nov. 17, 2006.

(51) Int. Cl. E06C 1/397

(52) U.S. Cl. 182/12

(57) ABSTRACT

A wheel assembly for a ladder stand having a vertical support and an adjacent longitudinal side member and including a first plate and a second plate mounted around the vertical support and the adjacent longitudinal side member of the ladder stand to form a housing and a wheel secured to the housing. An existing ladder stand with front and rear vertical supports can be converted into a tilt and roll ladder stand by mounting a wheel assembly to each of the front vertical supports. An activated position involves tilting the ladder stand such that the wheels of the wheel assemblies engage the ground so that the ladder can be moved and a deactivated position involves tilting the ladder stand in an opposite direction such that the wheels disengage the ground and the front and rear feet of the ladder stand contact the ground.

### CROSS REFERENCE TO RELATED APPLICATION

This application is based on U.S. Provisional Patent Application No. 60/859,821 filed Nov. 17, 2006 on which priority of this patent application is based and which the provisional patent application is hereby incorporated by reference in its entirety.

### BACKGROUND OF THE INVENTION

1. Field of the Invention

The invention relates to a ladder stand, and in particular, to one or more wheel assemblies which can be used to retrofit a ladder stand, wherein the ladder stand can be tilted forward so that the wheels of the wheel assemblies engage the floor or ground for movement of the ladder stand and wherein the ladder stand can be converted into a rolling ladder stand.

2. Description of Related Art

A tilt forward and roll ladder stand or a rolling ladder stand may in general have a base, support feet for stabilizing the ladder for safe use and wheels attached to the base so that the ladder stand can be tilted forward so that the wheels can engage the floor or ground for movement of the ladder stand from one location to another. In general, the wheels are part of a complicated structure for mounting the wheels to the ladder stand and are provided in the manufacture of the ladder stand. Also, the structure for mounting the wheels may be a welded structure and/or the wheels themselves may be welded to the tubing of the frame of the ladder stand.

U.S. Pat. Nos. 5,941,341; 6,039,147; and 6,962,233 B2 disclose rolling ladder stands that include front wheel sets, center wheel sets, rear wheel sets and front support feet. A lever system is associated with front and center wheel sets. This lever system is operated to an activated position, wherein the front and center wheel sets contact the ground to enable the ladder stand to roll and wherein the rear wheels and the front support feet are raised and do not come in contact with the ground. In this activated position, the ladder stand may be rolled from one location to another location. This lever system is also operated to a deactivated position wherein the front and center wheel sets are raised from the ground and the rear wheels and the front support feet come into contact with the ground to prevent the ladder stand from being rolled.

U.S. Pat. No. 6,230,841 B1 illustrates a track ladder having rollers that contact the ground for pivoting the track ladder about a vertical axis from one location to another location. These rollers are fixedly mounted or welded to the under surface of the first tread of the ladder during the manufacture of the track ladder.

There is a need therefore in the art to provide a wheel assembly that can be retrofitted to existing ladder stands and which can be easily mounted to and removed from ladder stands.

### SUMMARY OF THE INVENTION

The present invention has met this need. This invention relates to a wheel assembly that is mechanically fastened to a ladder stand for moving the ladder stand from one location to another location and for converting or retrofitting a ladder stand into a rolling or movable rolling stand or to a tilt and rolling ladder stand.

More particularly, the invention relates to a wheel assembly for a ladder stand having vertical supports and a longitudinal side member adjacent to each of the vertical supports and includes a first plate and a second plate mounted around one of the vertical supports and its adjacent longitudinal side member of the ladder stand to form a housing, and a wheel secured to the housing. The first and second plates may be injection molded plastic. The first plate includes a first cutout section for receiving the vertical support and a second cutout section for receiving the adjacent longitudinal side member of the ladder stand. The second plate includes a first cutout section for cooperating with the second cutout section of the ladder stand to receive the adjacent longitudinal side member of the ladder stand. The first plate is attached to the second plate through a system of fastening bolts and nuts, and the wheel is secured to the housing via an axle bolt and locking nut assembly. The two plates include a system of apertures for receiving the fastening bolts. Each of the two plates has a single aperture, and the wheel has a central aperture which cooperates with the single aperture of the two plates for receiving the axle bolt.

The invention further relates to a wheel assembly kit for attachment to a stationary ladder stand for converting the ladder stand to a rolling ladder stand. The kit includes a first plate and a second plate configured to be mounted around a vertical support and an adjacent side longitudinal member of the ladder stand to form a housing, and a wheel secured to the housing. The two plates may be injection molded plastic. The first plate includes a first cutout section configured to receive the vertical support and a second cutout section configured to receive the adjacent longitudinal side member of the ladder stand when the kit is assembled. The second plate includes a first cutout section for cooperating with the second cutout section of the first plate and configured to receive the longitudinal side member of the ladder stand when the kit is assembled. The kit further includes a system of fastening bolts and nuts and an axle bolt and locking nut assembly. The first plate is configured to be attached to the second plate through the system of fastening bolts and nuts to form a housing, and the wheel is secured to the housing through the axle bolt and locking nut assembly. The two plates include a system of apertures for receiving the fastening bolts. The first and second plates each include a single aperture and the wheel includes an aperture, wherein the aperture of the first plate, the aperture of the second plate and the aperture of the wheel are configured to receive the axle bolt.

The invention further relates to a movable ladder stand that includes a frame having a front and a rear, side supports, vertical supports located at the front and rear, and each containing support feet, a base including longitudinal side members located adjacent to the vertical supports and a plurality of stair treads supported by the side supports and extending upwardly at a fixed angle from the front to the rear thereof. The ladder assembly also includes a wheel assembly attached to a vertical support and an adjacent longitudinal side member of the ladder. The wheel assembly includes a first plate and a second plate mounted around the vertical support and the adjacent longitudinal side member of the ladder stand to form a housing and a wheel secured to the housing. The two plates may be injection molded plastic. The first plate includes a first cutout section for receiving the vertical support and a second cutout section for receiving the adjacent side longitudinal member. The second plate includes a cutout section for cooperating with the second cutout section of the first plate for receiving the adjacent longitudinal side member. The first plate is attached to the second plate through a system of fastening bolts and nuts, and the wheel is secured to the housing through an axle bolt and locking nut assembly. The first plate and the second plate include a system of apertures for receiving the fastening bolts. The first plate further includes a single aperture, the second plate further includes a single aperture and the wheel includes an aperture for receiving the axle bolt. The frame of the movable ladder further includes hand rails attached to the side supports and the vertical supports located to the rear of the frame of the ladder.

A method of the present invention relates to converting a ladder stand to a movable or rolling ladder stand having vertical supports located in the front and the rear of the ladder stand and a longitudinal side member located adjacent to the vertical supports. The steps of the method of the invention include: providing a wheel assembly for the vertical supports comprising a first plate having a system of apertures and configured to receive one vertical support of the ladder stand and an adjacent side longitudinal member, a second plate having a system of apertures and configured to receive the adjacent longitudinal side member, a wheel having a central aperture, a system of fastening bolts and nuts, and an axle bolt and locking nut assembly; positioning the first plate and the second plate in a vertical plane relative to one of the vertical supports and its adjacent side longitudinal member; inserting the fastening bolts through corresponding apertures of the first plate and the second plate; inserting the axle bolt through a corresponding single aperture of the first plate and the second plate and the central aperture of the wheel; and installing the nuts onto the fastening bolts and the locking nut onto the axle bolt so that the wheel is secured to the axle bolt along an outer surface of the second plate, and the second plate and the first plate are secured to the vertical support and its adjacent longitudinal side member. In an embodiment of the invention, a wheel assembly is provided for the vertical supports located in the front of the ladder stand and its adjacent side longitudinal member.

It is therefore an object of the invention to provide a wheel assembly for a tilt forward ladder stand that replaces currently welded and/or complicated structures for supporting a wheel assembly, thereby eliminating the need to manufacture a ladder stand specifically for a tilt and roll application.

It is still a further object of the invention to provide a wheel assembly kit for installation on a tilt forward ladder stand that allows the tilt forward ladder stand to be converted into a tilt and roll ladder stand or into a rolling or movable ladder stand.

These and other objects and advantages of the invention will be made apparent from the following description taken together with the drawings.

### BRIEF DESCRIPTION OF THE DRAWINGS

FIG. 1 is a perspective view of a tilt forward ladder stand;

FIG. 2 is a partial perspective view of the ladder stand of FIG. 1 showing a wheel assembly in exploded form and a wheel assembly in assembled form and attached to the ladder stand;

FIG. 3 is a top perspective view of a first plate and a second plate of the wheel assembly of FIG. 2;

FIG. 4 is a front elevation view of the ladder stand of FIG. 1;

FIG. 5 is a right side elevation view of the ladder stand of FIG. 1;

FIG. 6 is a rear elevation view of the ladder stand of FIG. 1;

FIG. 7 is a top plan view of the ladder stand of FIG. 1;

FIG. 8 is a left side elevation view of the ladder stand of FIG. 1; and

FIG. 9 is a bottom plan view of the ladder stand of FIG. 1.

### DETAILED DESCRIPTION OF THE INVENTION

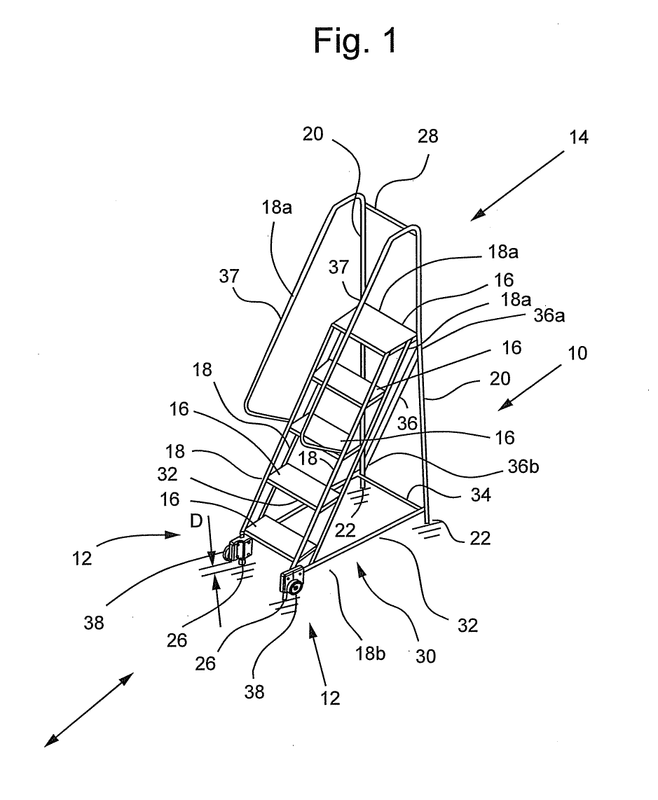

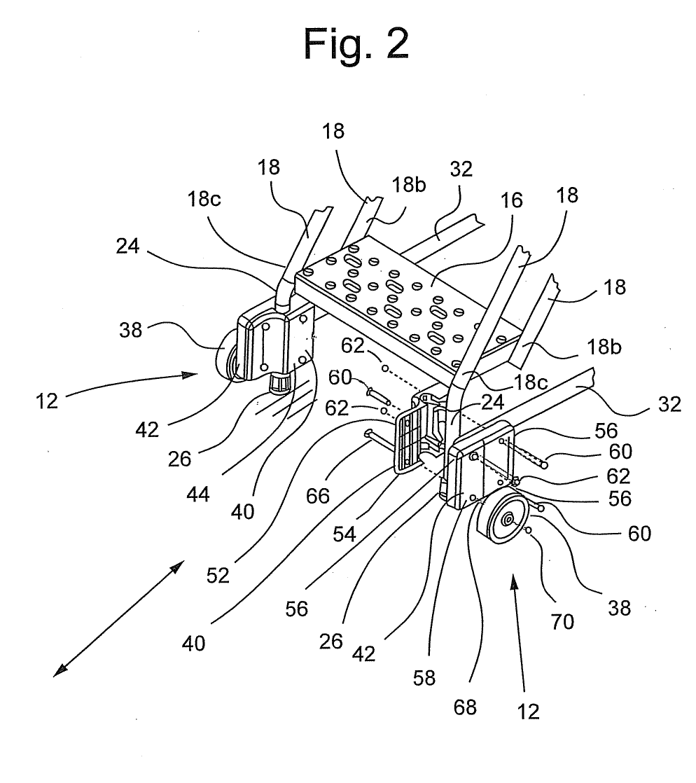

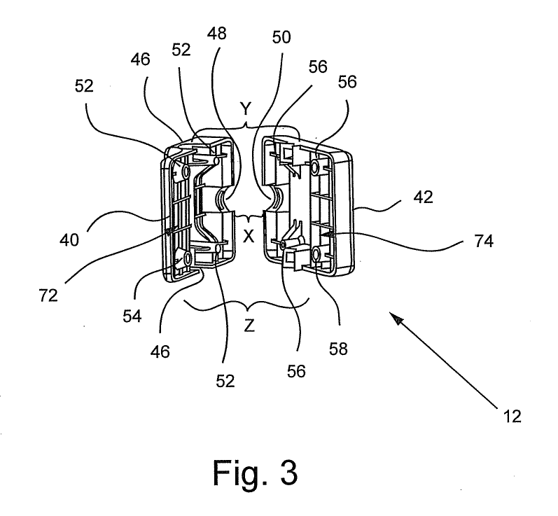

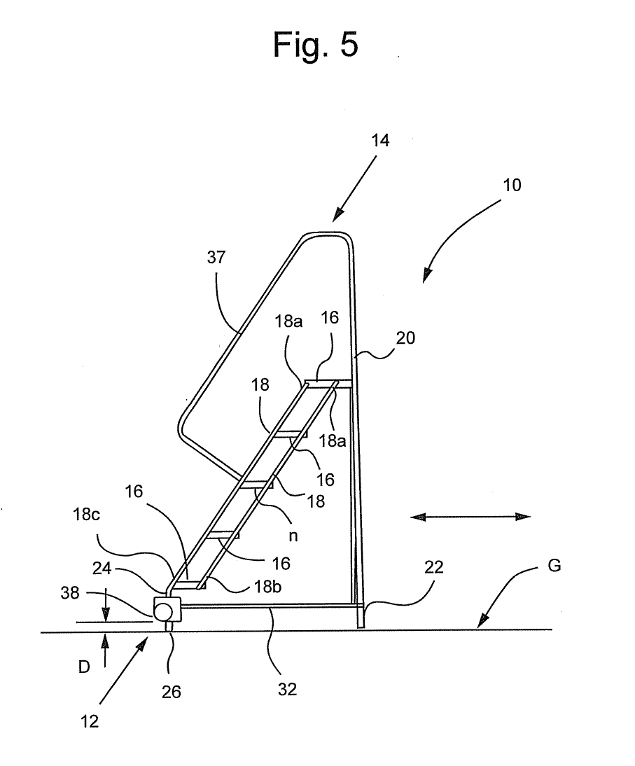

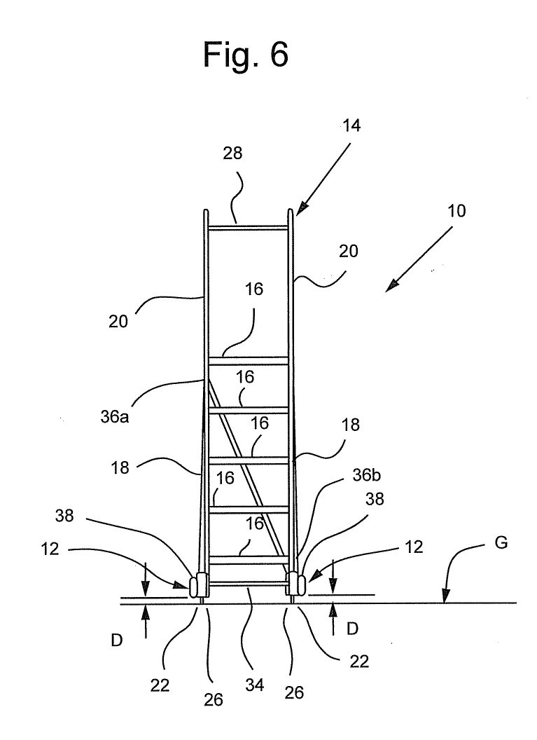

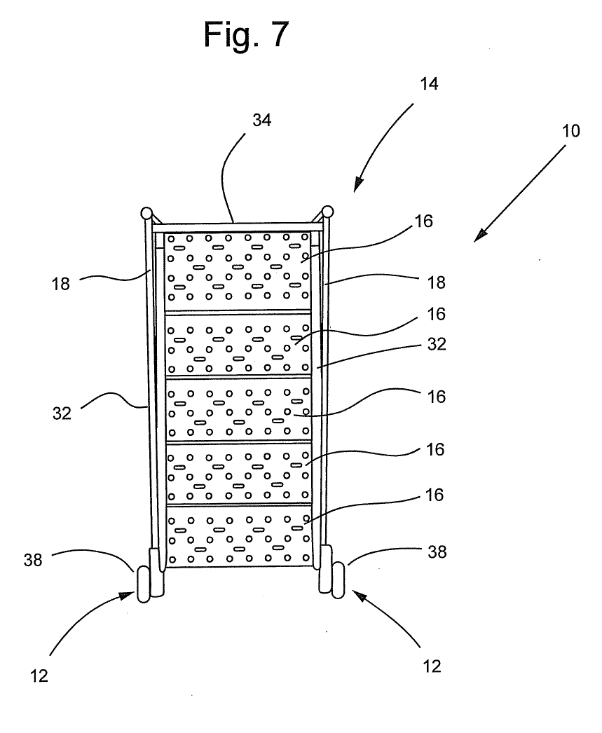

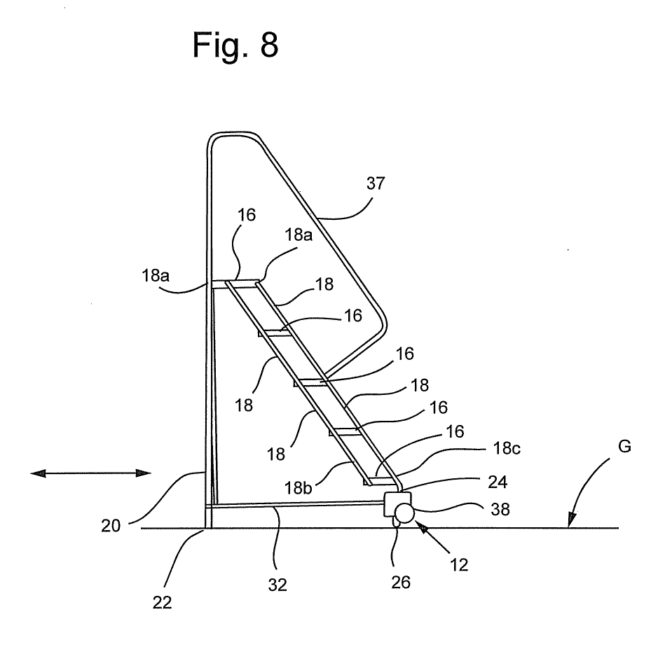

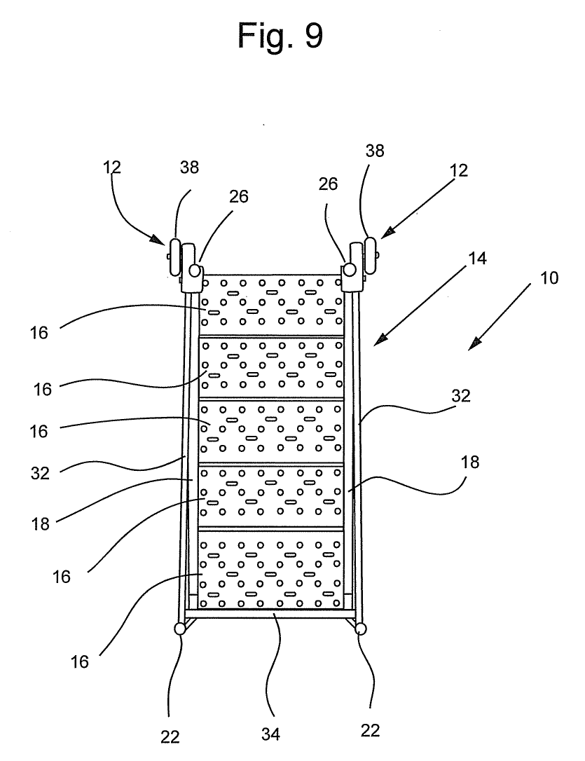

FIGS. 1 and 4-9 illustrate a tilt forward ladder stand generally indicated at 10 and includes two wheel assemblies generally indicated at 12, one located on either side of the front of ladder stand 10, and FIGS. 2-3 illustrate in more detail one such wheel assembly 12.

Referring to FIGS. 1-2 and 4-9, the tilt forward ladder stand 10 contains a frame generally indicated at 14. Frame 14 includes a plurality of spaced apart stair treads 16, side supports 18, rear vertical supports 20 containing rear support feet 22, front vertical supports 24 containing front support feet 26 (best shown in FIGS. 2, 5 and 8), a top cross beam 28, and a base generally indicated at 30. Base 30 is formed by longitudinal side members 32 and a lateral rear member 34. The longitudinal side members 32 are spaced apart and arranged parallel to each other, and along with lateral rear member 34 lie in a horizontal plane as best illustrated in FIG. 1. Frame 14 also includes two opposed hand rails 37 connected to each other via the top cross beam 28.

Still referring to FIGS. 1-2 and 4-9 and to frame 14, the plurality of stair treads 16 is supported by two spaced-apart, parallel side supports 18, which are mounted at an angle relative to the stair treads 16 and connected to the stair treads 16. Two sets of two spaced-apart, parallel side supports 18 are provided, wherein one such set is located on opposite sides of the stair treads 16. Upper portions 18a of each of the four side supports 18 are connected to and terminate at the uppermost stair tread 16 as best shown in FIG. 1. The lower portions 18b of the side supports 18 of each set are connected to and terminate at the bottom stair tread 16, as best shown in FIGS. 2, 5 and 8; whereas lower portions 18c of the upper side supports 18 of each set are connected to front vertical supports 24 as best shown in FIGS. 2, 5 and 8. As shown in FIGS. 1, 4 and 6, an additional brace or support beam 36 is provided between the two spaced-apart, parallel rear vertical supports 20 for stability. Support beam 36 is connected at an angle. One end of supports 36 is connected to the mid point of a rear vertical support 20 as indicated at 36a and the other end of support beam 36 is connected to the bottom of an opposite rear vertical support 20 as indicated at 36b for bracing or stabilizing the frame 14.

The several components, i.e., beams and supports of frame 14, described herein may be connected to each other by means well-known to those skilled in the art, e.g., welding or a combination of welding and fastening means, e.g., screws, nuts and bolts. Also, the various beams and supports may preferably be manufactured out of one-inch 16 gauge tubing which is standard in the industry. The design of the stair treads 16 and the various beams and supports are not critical to the invention, since the wheel assemblies 12 attached to the front of ladder stand 10 may also be used on other types of ladders or ladder stands.

As particularly illustrated in FIG. 2, wheel assembly 12 is mounted to the front vertical supports 24 and an adjacent longitudinal side member 32. Each wheel assembly 12 includes a wheel 38 which is affixed to the wheel assembly 12 so that it may rotate to move the ladder stand 10 in a direction shown by the double-headed arrow A illustrated in FIGS. 1, 2, 5 and 8. The wheels 38 in FIGS. 1, 2 and 4-9 are positioned above the ground G while the front vertical support feet 26 and the rear support feet 22 are supported by the ground G. The tilting of the ladder stand 10 forward causes the wheels 38 to engage the ground G in order to move the ladder stand 10. The wheels 38 may be of a form known to those skilled in the art, and generally may have a 4-inch diameter and a 1-inch depth.

Referring particularly to FIGS. 2 and 3, in addition to wheel 38, wheel assembly 12 includes an inward or first plate 40 and an outward or second plate 42. As particularly illustrated in FIG. 2, the first plate 40 and the second plate 42 are mounted around a front vertical support 26 and its adjacent longitudinal side member 32 to form a housing indicated at 44 which encloses a portion of the front vertical support feet 26 and a portion of its adjacent longitudinal side member 32 when the first plate 40 and the second plate 42 are assembled as illustrated to the left of FIG. 2.

As best illustrated in FIG. 3, the first plate 40 includes first cutout sections 46, one located in the top and one located in the bottom of first plate 40 for receiving the front vertical support foot 26 and a second cutout section 48 located along a side of first plate 40 for receiving the adjacent longitudinal side member 32. The second plate 42 includes a first cutout section 50 which cooperates with the second cutout section 48 of first plate 40 for receiving the adjacent longitudinal side member 32 of the frame 14 of ladder stand 10.

Still referring to FIG. 3, the first plate 40 also includes a system of apertures indicated at 52 and a single aperture indicated at 54, and the second plate 42 also includes a system of apertures indicated at 56 and a single aperture indicated at 58. The system of apertures 52 of the first plate 40 and the system of apertures 56 of the second plate 42 receive fastening bolts 60, which in turn, receive a locking nut 62. Wheel 38 of wheel assembly 12 further includes a central aperture 64. Central aperture 64, along with the single aperture 54 of the first plate 40, and the single aperture 58 of the second plate 42 receives an axle bolt 66, which in turn, receives an inner locking nut 68 and an outer locking nut 70. When plates 40 and 42 are assembled, the inner locking nut 68 is positioned between the second plate 42 and the wheel 38, whereas the outer locking nut 70 is positioned outwardly of the wheel 38.

Plates 40 and 42 may be plastic and made via an injection molding process or some other suitable material made via an appropriate process. The plates 40 and 42 shown in the figures are shown to be injection molded plastic and further include a rib and reinforcement system indicated in general at 72, 74, respectively, for rigidity purposes, as is well-known in the art. It is to be appreciated that when plates 40 and 42 are assembled, that the second cutout section 48 of first plate 40 and the first cutout section 50 of the second plate 42 form a circular opening or hole indicated by the “X” in at least FIG. 3 for encircling an adjacent longitudinal side member 32. It is to be further appreciated that the first cutout sections 46 in the top and bottom of the first plate 40 with reference to FIG. 3 have an opening that is sufficient to receive any diameter tubing used to form a front vertical support 24, particularly when the plates 40 and 42 are assembled. As best illustrated in FIG. 3, second plate 42 has a continuous depth, whereas the depth of the first plate 40 varies from the back to the front wherein the back has a greater depth than that of the front of plate 40.

First plate 40 and second plate 42 are reversible. That is, both plates 40, 42 are configured to be rotated such that they can be used on either side of the ladder stand 10. This is best exemplified in FIG. 2 wherein second plate 42 will always be positioned in an outward vertical plane and first plate 40 will always be positioned in an inward vertical plane opposite the second plate 42 and relative to a front vertical support 24 and its adjacent longitudinal side member 32. For assembling the wheel assembly 12 to the right in FIG. 2, plates 40 and 42 are positioned as shown in FIG. 2 such that the second cutout section 48 of first plate 40 and the first cutout section 50 of the second plate 42 cooperate to form an opening “X” (FIG. 3) for receiving the longitudinal side member 32, and the first cutout sections 46 in the top and bottom of first plate 40 receive the front vertical support 24. The first plate 40 and the second plate 42 are then brought together and either the fastening bolts 60 are inserted into the system of apertures 52 of the first plate 40 and the system of apertures 56 of the second plate 42 or the axle bolt 66 is inserted into the single aperture 54 of the first plate 40, the single aperture 58 of the second plate 42, through the inner locking nut 68 and then through the central aperture of wheel 38. At this time, the locking nuts 62 can be installed on bolts 60 and the outer locking nut 70 can be installed on axle bolt 66. In this manner, the two plates 40 and 42 are attached together, and the wheel 38 is secured to the axle bolt 66 such that the wheel 38 is spaced away from the outer surface of the second plate 42. The second plate 42 and the first plate 40 are secured to each of the front vertical supports 26 and the adjacent longitudinal side members 32.

The insertion of fastening bolts 60 and axle bolt 66 and the installation of locking nuts 62 and outer locking nut 70 can be done in a sequence that differs from that described in the preceding sentences for attaching the first plate 40, the second plate 42 and the wheel 38 together onto the front vertical supports 24 and the longitudinal side member 32 without diverting from the invention.

For assembling a wheel assembly 12 to the left side of ladder stand 10 of FIG. 2, plates 40 and 42 are positioned as shown in FIG. 2 such that the second cutout section 48 of first plate 40 and the first cutout section 50 of the second plate 42 cooperate to form an opening “X” (FIG. 3) for receiving the longitudinal side member 32, and the first cutout sections 46 in the top and bottom of first plate 40 receive the front vertical supports 24. In this instance, the inner first plate 40 is rotated 180 degrees upwardly in the plane of FIG. 2 such that the portion of the inner first plate 40 having the lesser depth points to the left as shown in FIG. 2. The first plate 40 and the second plate 42 are then brought together and either the fastening bolts 60 are inserted into the system of apertures 52 of the first plate 40 and the system of apertures 56 of the second plate 42 or the axle bolt 66 is inserted into the single aperture 54 of the first plate 40, the single aperture 58 of the second plate 42, through the inner locking nut 68 and then through the central aperture of wheel 38. At this time, the locking nuts 62 can be installed on bolts 60 and the outer locking nut 70 can be installed on axle bolt 66. In this manner, the two plates 40 and 42 are attached together and the wheel 38 is secured to the axle bolt 66 such that the wheel 38 is spaced away from the outer surface of the second plate 42, and the second plate 42 and the first plate 40 are secured to each of the front vertical supports 26 and the adjacent longitudinal side members 32.

The insertion of fastening bolts 60 and axle bolt 66 and the installation of locking nuts 62 and outer locking nut 70 can be done in a sequence that differs from that described in the preceding sentences for attaching the first plate 40, the second plate 42 and the wheel 38 together onto the front vertical support 24 and the longitudinal side member 32 without deviating from the invention.

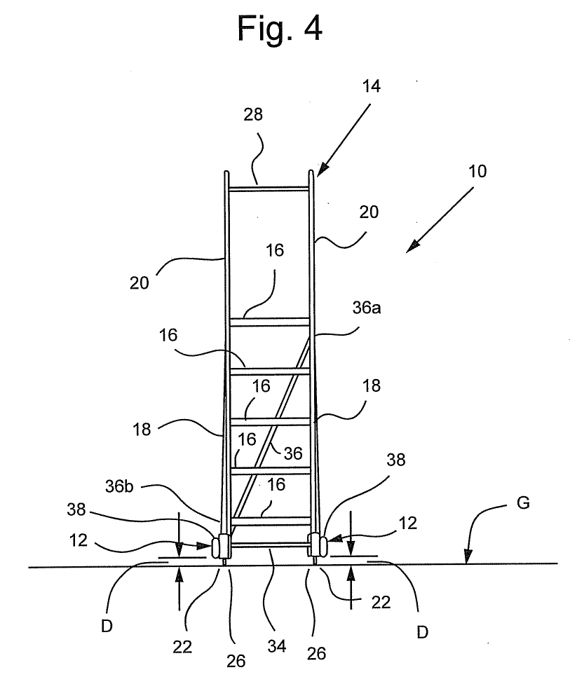

As can be appreciated, the wheel assembly 12 may be mounted to each of the front vertical support feet 26 of ladder stand 10 to form a tilt forward and roll ladder stand. In this regard, wheel 38 and its two reversible plates 40 and 42 mounted to each of the front vertical supports 24 convert or retrofit an already manufactured or existing ladder stand 10 into a tilt forward and roll ladder stand. The ladder stand 10 will have an activated position wherein it can be tilted forward such that the wheels 38 engage or contact the ground G in order to move the ladder stand 10 and a deactivated position wherein the ladder stand 10 can be tilted in an opposite direction such that the wheels 38 do not contact the ground G and the front vertical support feet 26 and the rear support feet 22 come into contact with the ground G thereby preventing the ladder stand 10 from rolling or being rolled. In other words, preferably, the wheels 38 are positioned so that they do not touch the ground G when the front vertical support feet 26 and the rear support feet 22 touch the ground G, and a lower portion of the wheels 38 are positioned a distance D above the ground G as shown in FIG. 4.

Even though the present invention has been described with reference to a wheel assembly 12 being mounted to each of the front vertical supports 24 for converting an existing ladder 10 into a tilt and roll ladder stand, it can be appreciated that wheel assembly 12 may instead be mounted to each of the rear vertical supports 20, particularly in a newly manufactured ladder stand. In this instance, the lateral member 34 may need to be positioned higher up from the ground G along the two rear vertical supports 20 with reference to FIG. 2. Also, wheel assembly 12 may be mounted to each of the front vertical supports 24 and to each of the rear vertical supports 20 for easy movement of the ladder stand in the directions indicated by the double-headed arrow A of FIG. 2.

It will be readily appreciated to those skilled in the art that modifications may be made to the invention without departing from the concepts disclosed in the foregoing description. Accordingly, the particular embodiments described in detail herein are illustrative only and are not limiting to the scope of the invention, which is to be given the full breadth of the appended claims and any and all equivalents thereof.

The invention claimed is:

1. A wheel assembly for a ladder stand having a vertical support and an adjacent longitudinal side member, said wheel assembly comprising:
a first plate;
a second plate;
the first plate and the second plate mounted around the vertical support and the adjacent longitudinal side member of the ladder stand to form a housing; and
a wheel secured to the housing.

2. The wheel assembly of claim 1 wherein the first plate and the second plate are injection molded plastic.

3. The wheel assembly of claim 1 wherein the first plate includes first cutout sections for receiving the vertical support and a second cutout section for receiving the adjacent longitudinal side member of the ladder stand; and
wherein the second plate includes a cutout section for cooperating with the second cutout portion of the first plate for receiving the adjacent longitudinal side member of the ladder stand.

4. The wheel assembly of claim 1 wherein the first plate is attached to the second plate through a system of fastening bolts and nuts; and
wherein the wheel is secured to the housing through an axle bolt and locking nut assembly.

5. The wheel assembly of claim 4 wherein the first plate and the second plate include a system of apertures for receiving the fastening bolts.

6. The wheel assembly of claim 5 wherein the first plate and the second plate include a single aperture and the wheel includes an aperture; and
wherein the single aperture of the first plate, the single aperture of the second plate and the aperture of the wheel are configured to receive the axle bolt.

7. A wheel assembly kit for attachment to a ladder stand for converting the ladder stand into a rolling ladder stand, the kit comprising:
a first plate;
a second plate;
the first plate and the second plate configured to be mounted onto a vertical support and an adjacent longitudinal side member of the ladder stand to form a housing; and
a wheel secured to the housing.

8. The wheel assembly kit of claim 7 wherein the first plate and the second plate are injection molded plastic.

9. The wheel assembly kit of claim 7 wherein the first plate includes first cutout sections configured to receive the vertical support and a second cutout section for receiving the adjacent longitudinal side member of the ladder stand when the kit is assembled; and
wherein the second plate includes a cutout section configured to cooperate with the second cutout section of the first plate for receiving the adjacent longitudinal side member of the ladder stand when the kit is assembled.

10. The wheel assembly kit of claim 7 further comprising a system of fastening bolts and nuts and an axle bolt and locking nut assembly;
wherein the first plate is configured to be attached to the second plate through the system of fastening bolts and nuts; and
wherein the wheel is secured to the housing through the axle bolt and locking nut assembly.

11. The wheel assembly kit of claim 10 wherein the first plate and the second plate include a system of apertures for receiving the fastening bolts.

12. The wheel assembly kit of claim 11 wherein the first plate and the second plate include a single aperture and the wheel includes an aperture; and
wherein the single aperture of the first plate, the single aperture of the second plate and the aperture of the wheel are configured to receive the axle bolt.

13. A movable ladder stand, comprising:
a frame having a front and a rear, side supports, vertical supports containing support feet and located in the front and the rear of the frame, a base including longitudinal side members and a lateral member, and a plurality of stair treads supported by the side supports and extending upwardly at a fixed angle from the front to the rear thereof; and
a wheel assembly attached to each of the vertical supports optionally located on the rear or the front of the frame and the adjacent longitudinal side member of the ladder stand,
the wheel assembly comprising:
a first plate;
a second plate;
the first plate and the second plate mounted on the vertical support and an adjacent longitudinal side member of the base to form a housing; and
a wheel secured to the housing.

14. The movable ladder stand of claim 13 wherein the first plate and the second plate are injection molded plastic.

15. The movable ladder stand of claim 13 wherein the first plate includes first cutout sections for receiving the vertical support and a second cutout section for receiving the adjacent longitudinal side member of the ladder stand; and
wherein the second plate includes a cutout section for cooperating with the second cutout section of the first plate for receiving the adjacent longitudinal side member of the ladder stand.

16. The movable ladder stand of claim 13 wherein the first plate is attached to the second plate through a system of fastening bolts and nuts; and
wherein the wheel is secured to the housing through an axle bolt and locking nut assembly.

17. The movable ladder stand of claim 16 wherein the first plate and the second plate include a system of apertures for receiving the fastening bolts.

18. The movable ladder stand of claim 17 wherein the first plate and the second plate each include a single aperture and the wheel includes an aperture; and
wherein the single aperture of the first plate, the single aperture of the second plate and the aperture of the wheel are configured to receive the axle bolt.

19. The movable ladder stand of claim 13 wherein the frame further includes hand rails attached to the side supports and the rear vertical support beams.

20. A method for converting a ladder stand into a movable ladder stand having vertical supports located in the rear and the front and two longitudinal side members, each located adjacent to one of the vertical supports, the steps comprising:
providing a wheel assembly for each of the vertical supports and an adjacent longitudinal side member comprising a first plate having a system of apertures and configured to receive one vertical support of the ladder stand and an adjacent longitudinal side member, a second plate having a system of apertures and configured to receive the adjacent longitudinal side member, a wheel having a central aperture, a system of fastening bolts and nuts, and an axle bolt and locking nut assembly;
positioning the first plate and the second plate in a vertical plane opposite to each other and relative to the vertical support and the adjacent longitudinal side member;
inserting the fastening bolts through corresponding apertures of the first plate and the second plate,
inserting the axle bolt through a corresponding single aperture of the first plate and the second plate and through the central aperture of the wheel; and
installing the nuts onto the fastening bolts and the locking nut onto the axle bolt so that the wheel is secured and spaced away from the outer surface of the second plate, and the second plate and the first plate are secured to the vertical support and the adjacent longitudinal side member.
